(19) United States
(12) Patent Application Publication
(10) Pub. No.: US 2026/0081836 A1
(43) Pub. Date: Mar. 19, 2026

(54) METHOD AND SYSTEM FOR POLICY CONTROL FUNCTION SELECTION SERVICE

(71) Applicant: Verizon Patent and Licensing Inc., Basking Ridge, NJ (US)

(72) Inventors: Shanthala Kuravangi-Thammaiah, Keller, TX (US); Lixia Yan, Basking Ridge, NJ (US); Jerry Steben, Fort Worth, TX (US)

(21) Appl. No.: 18/887,233

(22) Filed: Sep. 17, 2024

(51) Int. Cl. H04L 41/0894; H04L 65/1069

(52) U.S. Cl. CPC H04L 41/0894; H04L 65/1069

(57) ABSTRACT

A method, an end device, and a non-transitory computer-readable storage medium are described in relation to a policy control function (PCF) selection service. The PCF selection service may include storing context information, which includes data indicating identifiers associated with a selected PCF or SM-PCF, with a unified data storage device. The context information may be used by session management functions (SMFs) of the same or different SMF set. The PCF selection service may include storing subscription data of an end device indicating that the same PCF set or the same session management (SM)-PCF set are to be selected for all packet data unit sessions of the end device. The PCF selection service may enable an access and mobility management function to provide the context information to an SMF or the SMF may obtain the context information locally or from the unified data storage device.

### BACKGROUND

In a Fifth Generation (5G) core (5GC) network or another type of network, a policy control function (PCF) or another type of policy control network device may be configured with various types of policies to which other network devices and end devices may adhere.

### BRIEF DESCRIPTION OF THE DRAWINGS

FIG. 1 is a diagram illustrating an exemplary environment in which an exemplary embodiment of a PCF selection service may be implemented;

FIGS. 2A and 2B are messaging diagrams illustrating an exemplary process of an exemplary embodiment of the PCF selection service according to an exemplary scenario;

FIG. 3 is a diagram illustrating exemplary components of a device that may correspond to one or more of the devices illustrated and described herein;

FIG. 4 is a flow diagram illustrating an exemplary process of an exemplary embodiment of the PCF selection service;

FIGS. 5A and 5B are messaging diagrams illustrating another exemplary process of an exemplary embodiment of the PCF selection service according to an exemplary scenario; and

FIG. 6 is a flow diagram illustrating another exemplary process of an exemplary embodiment of the PCF selection service.

### DETAILED DESCRIPTION

The following detailed description refers to the accompanying drawings. The same reference numbers in different drawings may identify the same or similar elements. Also, the following detailed description does not limit the invention.

A policy control device of a network, such as a PCF, may be configured with various policies, such as packet data unit (PDU) session management (SM) policies, access and mobility (AM)-related policies, and user equipment (UE) access selection and PDU session related policies. The provisioning of policies regarding each end device may involve various communication exchanges between different network devices of the core network. For example, depending on the type of session, there may be different PCFs configured with policies pertaining to the type of session. For example, for a particular end device, there may be different PCFs regarding an Internet PDU session, an Internet Protocol Multimedia Subsystem (IMS) PDU session, an application PDU session, an administrative PDU session, and so forth. Each PCF may communicate with the same type of network device (e.g., a unified data repository (UDR), a charging function (CHF), a unified data management (UDM), etc.) via communication links. Additionally, for example, there may be different session management functions (SMFs) that may be configured to manage different PDU sessions associated with the same end device. As a result of this configuration, PDU sessions associated with the same end device can yield numerous communications and transactions amongst network devices and sub-optimal usage of resources.

According to various exemplary embodiments, a PCF selection service is described. According to various exemplary embodiments, the PCF selection service may pertain to on-net (e.g., home service provider relative to a user and/or end device) and/or off-net (e.g., non-home service provider relative to the user and/or the end device; roaming) PDU sessions, Quality of Service (QoS) flows, packet data network (PDN) connections, or another form of user plane data flows, for example.

According to an exemplary embodiment, the PCF selection service may include session management subscription data that includes data indicating that an SMF, which is associated with an end device, may select and use a same PCF set or a same SM-PCF set for all data network names (DNNs) and/or PDU (DNN/PDU) sessions associated with the end device.

According to an exemplary embodiment, the DNN/PDU sessions may be of varying types, as described herein. According to various exemplary embodiments, across multiple DNN/PDU sessions of the end device in which multiple SMFs may be selected and used, the SMFs may belong to the same SMF set or different SMF sets.

According to an exemplary embodiment, the PCF selection service may include storing an identifier (ID) with a UDM. According to an exemplary implementation, the identifier may be stored as or included in context information (e.g., UE PDU context information). According to various exemplary implementations, the identifier may include an instance ID (e.g., an ID that uniquely identifies a PCF or an SM-PCF instance), a set ID (e.g., an ID that identifies a PCF set or an SM-PCF set), a group ID (e.g., an ID that identifies one or multiple PCF or SM-PCF sets that may manage a set of end devices or subscription permanent identifiers (SUPIs)) or a sub-combination of these IDs (e.g., instance ID and set ID, etc.). For example, a first SMF that is selected to manage a first or an initial PDU session of the end device, may locally store (e.g., at the first SMF) and store in the UDM or the like, the context information. In this way, a second or prospective PDU session of the end device, which may be assigned to a second SMF of the same SMF set as the first SMF or may belong to a different SMF set, may select the same PCF set or SM-PCF set as the first SMF based on the subscription data and the context information retrieved from the UDM or the like, as described herein. According to some exemplary embodiments, depending on the configurations of the PCFs or the SM-PCFs and the type of DNN/PDU session, the second SMF may or may not select the same PCF (of the same PCF set) or the same SM-PCF (of the same SM-PCF set) as the first SMF.

According to an exemplary embodiment, for on-net and off-net PDU sessions, the PCF selection service may enable an access and mobility management function (AMF) to provide context information to an SMF associated with an end device, that allows the SMF to select the same PCF set or the same SM-PCF set for all on-net DNN/PDU sessions, as described herein. According to an exemplary embodiment, a first SMF associated with a first or initial PDU session of an end device, may store the context information at a UDM or the like. For example, the context information may include an identifier (e.g., an instance ID, a set ID, and a group ID, or a sub-combination of IDs), as described herein. As a part of a second or another PDU session establishment procedure regarding the end device, the AMF may retrieve the context information from the UDM or the like and provide the context information to a second SMF. In this way, an SMF of the same SMF set or of a different SMF set relative to the first SMF of the first or initial PDU session, may select and use the same PCF set or the same SM-PCF. According to some exemplary embodiments, depending on the configurations of the PCFs or the SM-PCFs and type of DNN/PDU session, the second SMF(s) may or may not select the same PCF (of the same PCF set) or the same SM-PCF (of the same SM-PCF set) as the first SMF. In this way, the same PCF set or the same SM-PCF set for all on-net DNN/PDU sessions associated with the end device may be selected and used.

In view of the foregoing, the PCF selection service may reduce and optimize network resource utilization regarding PCF selection and session establishment procedures. For example, the number of communications and transactions between various network devices, such as a PCF, an SM-PCF, a UDR, a UDM, a CHF, etc., pertaining to an end device may be minimized.

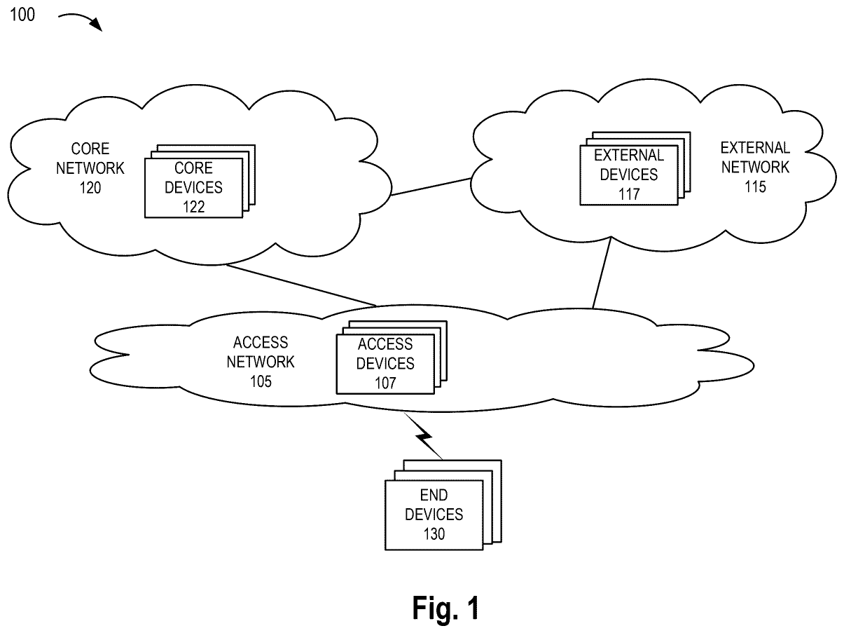

FIG. 1 is a diagram illustrating an exemplary environment 100 in which an exemplary embodiment of the PCF selection service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually and generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the PCF selection service may use at least one of these planes of communication.

An interface of a network device may be modified (e.g., relative to an interface defined by a standards body, such as Third Generation Partnership Project (3GPP), 3GPP2, International Telecommunication Union (ITU), European Telecommunications Standards Institute (ETSI), GSM Association (GSMA), etc.) or a new interface of the network device may be provided in order to support the communication (e.g., transmission and reception of messages, IEs, attribute value pairs (AVPs), etc.) between network devices and the PCF selection service logic of the network device, as described herein. According to various exemplary implementations, the interface of the network device may be a service-based interface, a reference point-based interface, an Open Radio Access Network (O-RAN) interface, or some other type of interface.

Access network 105 may include one or multiple networks of one or multiple types and technologies. For example, access network 105 may be implemented to include a Fifth Generation (5G) RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 105 may include a legacy RAN (e.g., a Third Generation (3G) RAN, a Fourth Generation (4G) RAN, etc.). Access network 105 may communicate with and/or include other types of access networks, such as, for example, a Wi-Fi network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a Wi-Fi device, a hotspot device, a fixed wireless access CPE (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

External network 115 may include one or multiple networks of one or multiple types and technologies that provide an end device application service. For example, external network 115 may be implemented using one or multiple technologies including network function virtualization (NFV), SDN, cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a virtual network, a packet-switched network, a data center, a data network, or other type of application service layer network that may provide access to and may host an end device application service.

External devices 117 may host one or multiple types of end device application services. For example, an end device application service may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (IoT) (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) network of an LTE network, an LTE-Advanced (LTE-A) network, and/or an LTE-A Pro network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an AMF, an SMF, a UDM device, a UDR device, an authentication server function (AUSF), a security anchor function (SEAF), a network exposure function (NEF), a network slice selection function (NSSF), a network repository function (NRF), a PCF, a network data analytics function (NWDAF), a service capability exposure function (SCEF), a lifecycle management (LCM) device, a mobility management entity (MME), a packet data network (PDN) gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy control repository function (PCRF), a policy and charging enforcement function (PCEF), a CHF, a charging system (CS), and/or a future generation core network device that may provide similar functions and/or services as those described herein.

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, 6G and 7G, etc.), such as an SMF with PGW control plane functionality (e.g., SMF+PGW−C), a UPF with PGW user plane functionality (e.g., UPF+PGW−U), and/or other combined nodes (e.g., an HSS with a UDM and/or UDR, an MME with an AMF, a converged charging system (CCS), etc.). Also, core devices 122 may include a split core device 122. For example, core devices 122 may include an SM-PCF, an AM-PCF, a UE-PCF, and/or another type of split architecture associated with another core device 122, as described herein.

According to an exemplary embodiment, at least some of core devices 122 may include logic of the PCF selection service and/or perform an operation that supports or facilitates the PCF selection service, as described herein. For example, an AMF, an SMF, a UDM, a UDR, an NRF, and/or another type of core device 122 may provide or support an exemplary embodiment of the PCF selection service, as described herein.

End device 130 may include a device that may have computational and communication capabilities (e.g., wireless, wired, optical, etc.). End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a music device, an IoT device, a drone, or another type of UE.

End device 130 may be configured to execute various types of software (e.g., applications, programs, etc.). The number and the types of software may vary among end devices 130. For example, end device 130 may host one or multiple end device applications that may relate to diverse types of application services described in relation to external devices 117. For example, the end device application may pertain to IoT, extreme real-time communications, gaming, voice, video-calling, navigation, ultra-reliable communications, and so forth. The end device application may include a client-side application.

End device 130 may include “edge-aware” and/or “edge-unaware” application service clients. End device 130 may be implemented as a virtualized device in whole or in part. For purposes of description, end device 130 is not considered a network device.

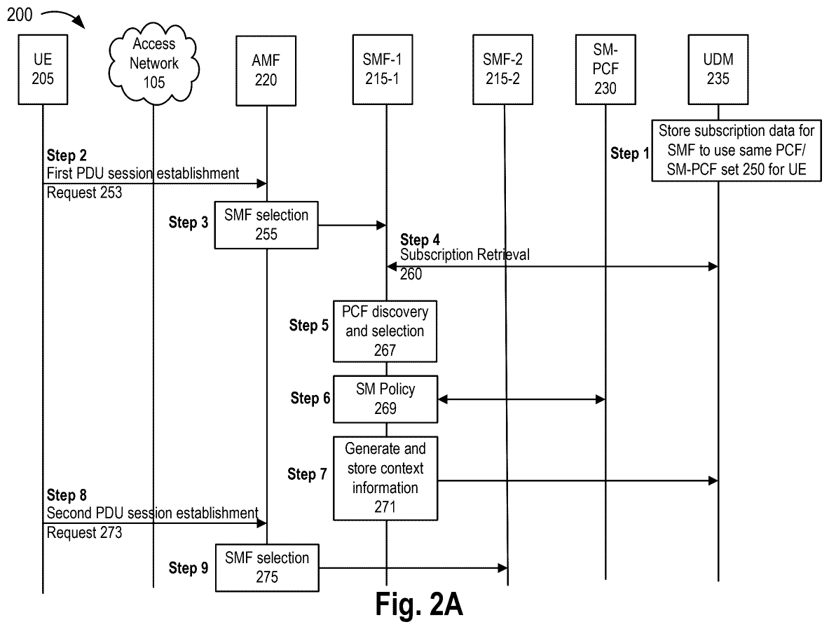

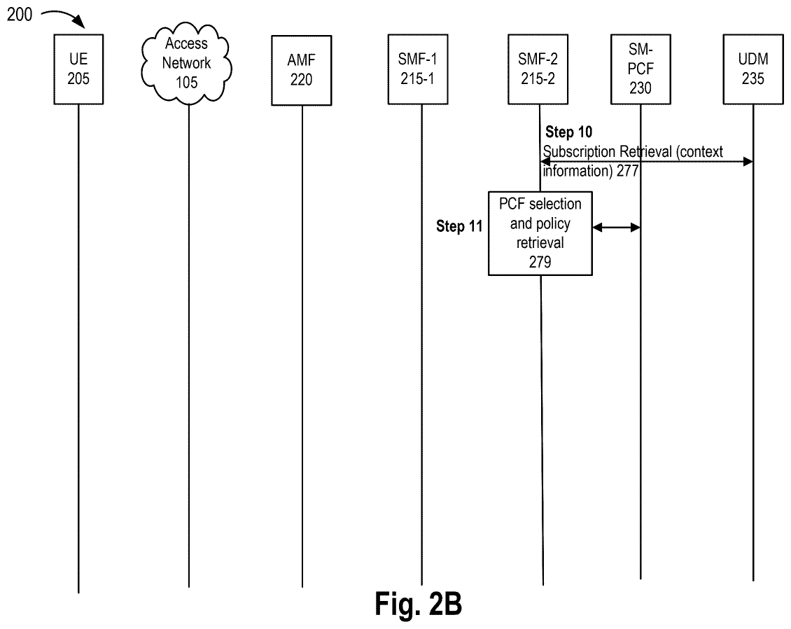

FIGS. 2A and 2B are messaging diagrams illustrating an exemplary process 200 of an exemplary embodiment of the PCF selection service according to an exemplary scenario and environment. As illustrated, the exemplary environment may include a UE 205 (e.g., end device 130), access network 105, an SMF 215-1, an SMF 215-2, an AMF 220, an SM-PCF 230, and a UDM 235. The environment depicted in FIGS. 2A and 2B is exemplary. According to various exemplary scenarios, the steps of process 200 may pertain to an on-net use case or an off-net use case.

The messages illustrated and described in relation to FIGS. 2A and 2B and process 200 are exemplary. For the sake of brevity, some operations and/or messages, which may relate to the establishment of a PDU session in accordance with a network standard, have been omitted. The order of steps illustrated and described are also exemplary, and non-dependent steps may be performed concurrently.

SMF 215, AMF 220, SM-PCF 230, and UDM 235 may each provide a function and/or a service in accordance with a network standard (e.g., set forth in a technical specification (TS)) associated with a network standards entity, such as 3GPP, 3GPP2, ITU, ETSI, GSMA, and/or the like. For example, SMF 215 may provide session management, Internet Protocol (IP) address allocation and management, selection, and control of user plane function, configuration of traffic steering, control of policy enforcement and quality of service (QoS), among other functions. AMF 220 may provide registration, connection, reachability and mobility management, security context management, location service management, and UE mobility event notification, among other functions. SM-PCF 230 may store and provide policies to control plane functions, among other functions. UDM 235 may manage data access authorization, user registration, and data network profiles, and store various types of data, such as subscription data, policy information, and user-related data (e.g., application specific data, user profiles, etc.), among other functions. According to an exemplary embodiment, SMF 215 may include logic of an exemplary embodiment of the PCF selection service. For example, SMF 215 may perform a function, an operation, and/or a service that is beyond a function and/or service associated with a network standard.

In step (1), UDM 235 may store subscription data that includes data indicating to use the same PCF set or SM-PCF set 250 for all DNN/PDU sessions associated with UE 205.

In step (2), UE 205 may generate and transmit a PDU session establishment request 253 to AMF 220. Request 253 may include various types of data, such as a PDU session ID, PDU session type, core network capability information, among other types of information (e.g., single network slice selection assistance information (S-NSSAI), etc.). According to this exemplary scenario, the request type may be an initial request. For example, request 253 may be the first or the initial PDU session request after completion of registering with core network 120.

In step (3), AMF 220 may perform an SMF selection 255. For example, AMF 220 may use an NRF (not illustrated) to discover an SMF or use SMF information that may be locally stored or configured. AMF 220 may select the SMF based on subscription information from UDM 235, selected DNN, the S-NSSAI, access technology used by UE 205, and/or other criteria. According to this exemplary scenario, assume that AMF 220 may select SMF-1 215-1 as the SMF to manage the first PDU session establishment request procedure.

In step (4), SMF-1 215-1 may perform a subscription retrieval procedure 260 with UDM 235. For example, SMF-1 215-1 may retrieve session management subscription data pertaining to UE 205. According to an exemplary embodiment, the session management subscription data may include data indicating that the same PCF set or SM-PCF set is to be used for all DNN/PDU sessions associated with UE 205. As an example, the data may be implemented as a Boolean data instance (e.g., SM-PCF constant=True) or another form or type of data instance.

In step (5) SMF-1 215-1 may perform a PCF discovery and selection procedure 267. For example, SMF-1 215-1 may query the NRF (not illustrated) to discover a PCF or an SM-PCF. Based on a result of the query, SMF-1 215-1 may select SM-PCF 230. For example, SMF-1 215-1 may select SM-PCF 230 based on the SUPI of UE 205, the subscription data, and/or other types of data (e.g., the DNN, S-NSSAI of the prospective PDU session, information provided by AMF 220, etc.). In step (6), SMF-1 215-1 may obtain SM policies 269 pertaining to UE 205 from SM-PCF 230. For example, the policies may relate to a particular DNN and network slice.

In step (7), SMF-1 215-1 may generate and store context information 271 pertaining to the selection of SM-PCF 230. For example, based on the session management subscription data and the PCF/SM-PCF selection, SMF-1 215-1 may generate and locally store an identifier pertaining to SM-PCF 230, as described herein. By way of further example, the identifier may include an instance ID and a set ID. According to other examples, the identifier may include a different set of IDs, as described herein. Additionally, as further illustrated in FIG. 2A, SMF-1 215-1 may store the context information with UDM 235. According to various exemplary embodiments, the context information may include other types of data, such as a DNN, a destination fully qualified domain name (FQDN), a PDU session ID, S-NSSAI, and/or other types of SM context data that may pertain to the PDU session.

Although not illustrated, according to an exemplary scenario, assume that UE 205 establishes and conducts a PDU session with an application server (e.g., external device 117 of external network 115, not illustrated).

Thereafter, in step (8), UE 205 may generate and transmit another PDU session establishment request 273 to AMF 220. According to this exemplary scenario, assume that request 273 relates to a different DNN relative to request 253. In step (9), AMF 220 may perform an SMF selection procedure 275, and as a result, selects SMF-2 215-2 to manage this PDU session.

Referring to FIG. 2B, in step (10), SMF-2 215-2 may retrieve subscription information 277, which includes the context information, from UDM. In step 11, SMF-2 215-2 may select a PCF or an SM-PCF from the same PCF set or SM-PCF set as SMF-1 215-1 based on the retrieved context information. According to this example, SMF-2 215-2 may select the same SM-PCF (i.e., SM-PCF 230) as SMF-1 215-1. According to other exemplary scenarios, SMF-2 215-2 may select a different SM-PCF but from the same SM-PCF set as SMF-1 215-1 selected.

Although not illustrated, according to an exemplary scenario, assume that UE 205 establishes and conducts a second PDU session with an application server (e.g., external device 117 of external network 115, not illustrated) of a different network than the first PDU session. The number of PDU sessions illustrated and described are exemplary, and the number of PDU sessions established subsequent to the first or initial PDU session is not limited to a single PDU session (e.g., a second PDU session). Accordingly, the PCF selection service may enable the selection of PCF(s) and/or SM-PCF(s) associated with the same set for more than two PDU/DNN sessions.

FIGS. 2A and 2B illustrate exemplary process 200 of an exemplary embodiment of the PCF selection service, according to other exemplary processes, different and/or additional processes or operations may be performed. For example, according to another exemplary scenario, if in step (9) AMF 220 selected SMF-1 215-1 to manage the second PDU session, SMF-1 215-1 may use the locally stored context information to select a PCF or an SM-PCF from the same set as the set associated with the first PDU session.

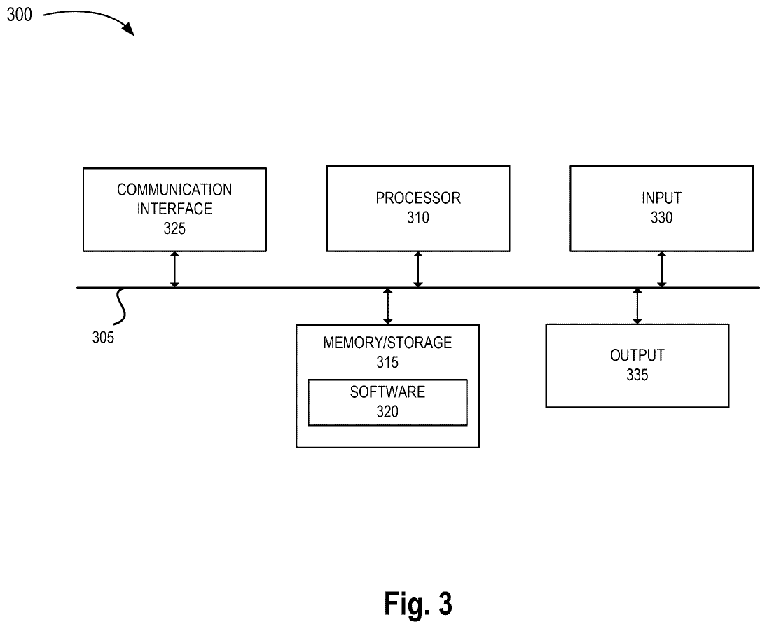

FIG. 3 is a diagram illustrating exemplary components of a device 300 that may be included in one or more of the devices described herein. For example, device 300 may correspond to access device 107, external device 117, core device 122, end device 130, UE 205, SMF 215, AMF 220, SM-PCF 230, UDM 235, and so forth. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, mass storage, off-line storage, or some other type of storing medium. Memory/storage 315 may store data, software, and/or instructions related to the operation of device 300.

Software 320 includes an application or a program that provides a function and/or a process. As an example, with reference to core device 122 or SMF 215, software 320 may include an application that, when executed by processor 310, provides a function and/or a process of the PCF selection service, as described herein. As another example, with reference to AMF 220, software 320 may include an application that, when executed by processor 310, provides a function and/or a process of the PCF selection service, as described herein. Software 320 may also include firmware, middleware, microcode, hardware description language (HDL), and/or another form of instruction. Software 320 may also be virtualized. Software 320 may further include an operating system (e.g., Windows, Linux, Android, proprietary, etc.).

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers, an antenna, and the like. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 300 may be configured to perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 may configure processor 310 to perform a function, an operation, or a process described herein. Alternatively, for example, according to other implementations, device 300 may be configured to perform a function, an operation, or a process described herein based on the execution of hardware (processor 310, etc.).

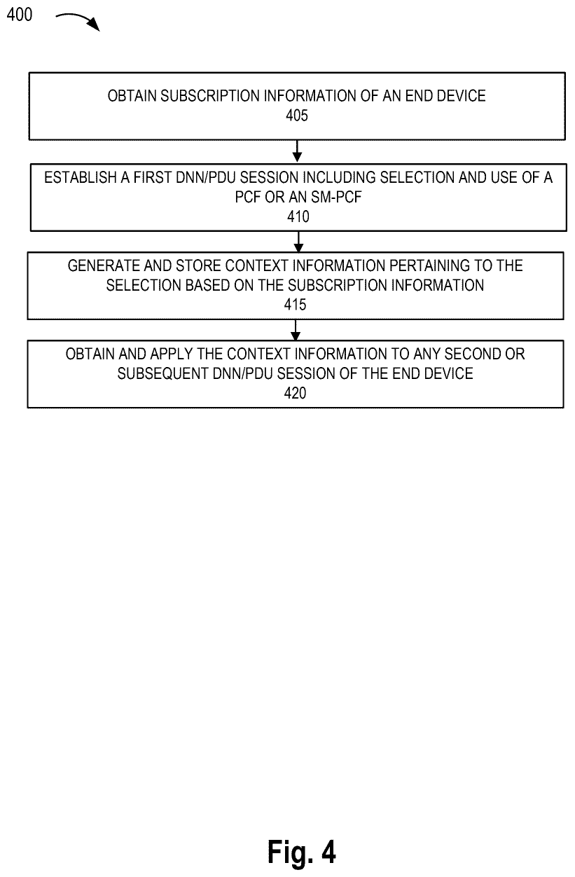

FIG. 4 is a flow diagram illustrating an exemplary process 400 of an exemplary embodiment of the PCF selection service. According to an exemplary embodiment, an SMF may perform steps of process 400. According to an exemplary implementation, a processor may execute software to perform a step (in whole or in part) of process 400, as described herein. Alternatively, a step (in whole or in part) may be performed by execution of only hardware. Process 400 may be performed for on-net and off-net use cases in relation to end device 130.

In block 405, the SMF may obtain subscription information of end device 130. For example, the SMF may obtain subscription information from a UDM (e.g., UDM 235). According to an exemplary embodiment, the subscription information may include data indicating to use the same PCF set or SM-PCF set for all DNN/PDU sessions associated with end device 130.

In block 410, the SMF may establish a first DNN/PDU session including selection and use of a PCF or an SM-PCF. For example, the SMF may perform operations that assist in the establishment of the first DNN/PDU session of end device 130, as described herein.

In block 415, the SMF may generate and store context information pertaining to the selection of the PCF or the SM-PCF. For example, the SMF may generate and locally store the context information and store the context information with the UDM, as described herein, based on the subscription information (e.g., the data indicating to use the same PCF set or the same SM-PCF set for all DNN/PDU sessions associated with end device 130) and the data associated with the selected PCF or SM-PCF.

In block 420, the SMF may obtain and apply the context information to any second or subsequent DNN/PDU session of end device 130. For example, the SMF may obtain the context information (locally or from the UDM), and select a PCF or an SM-PCF from the same set as the first DNN/PDU session based on the context information, as described herein. The SMF may determine to obtain the context information at the UDM when the context information does not exist locally for end device 130.

FIG. 4 illustrates an exemplary process 400 of the PCF selection service, however, according to other exemplary embodiments, the PCF selection service may perform additional operations, fewer operations, and/or different operations than those illustrated and described in relation to FIG. 4.

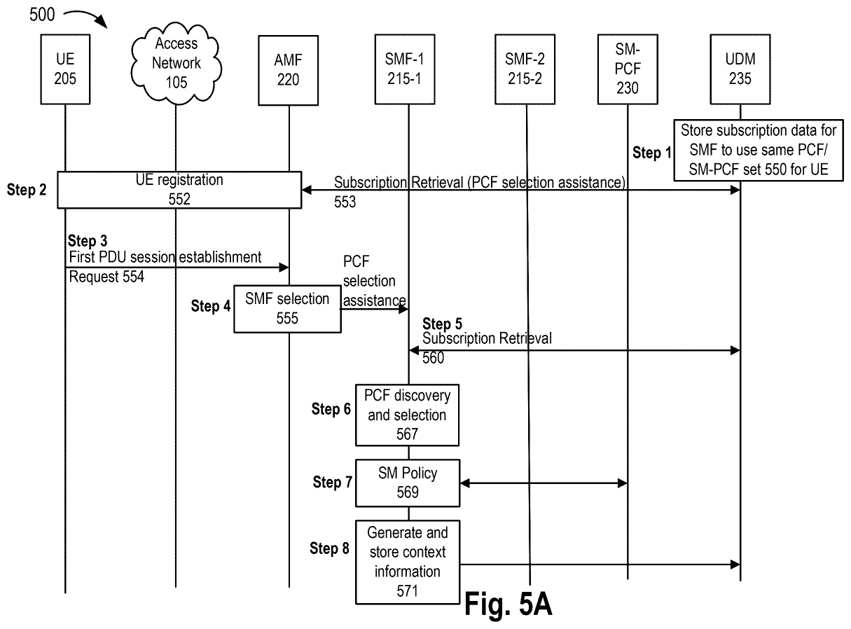

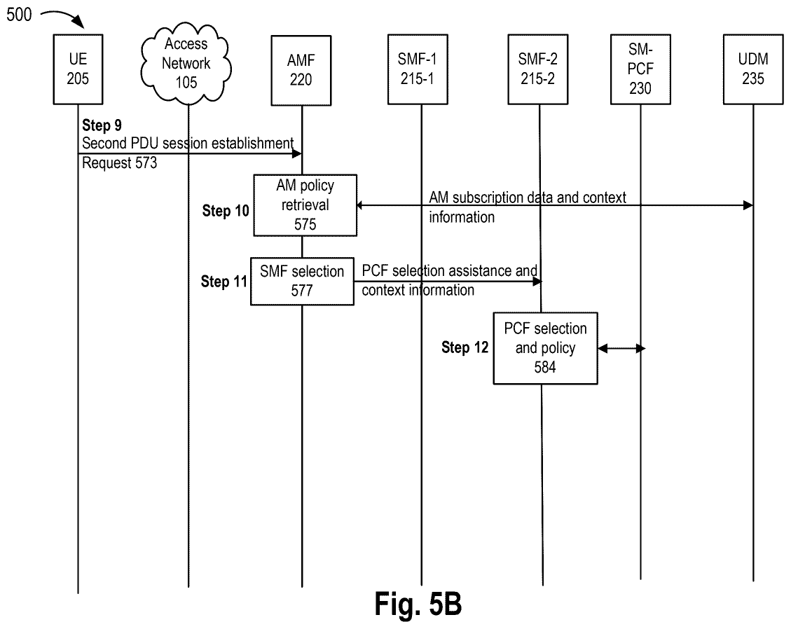

FIGS. 5A and 5B are messaging diagrams illustrating an exemplary process 500 of an exemplary embodiment of the PCF selection service according to an exemplary scenario and environment. As illustrated, the exemplary environment may include UE 205, access network 105, SMF 215-1, SMF 215-2, AMF 220, SM-PCF 230, and UDM 235. According to an exemplary embodiment, SMF 215 and AMF 220 may each include logic of the PCF selection service. The environment depicted in FIGS. 5A and 5B is exemplary. According to an exemplary scenario, the steps of process 500 may pertain to a non-roaming or on-net use case.

The messages illustrated and described in relation to FIGS. 5A and 5B and process 500 are exemplary. For the sake of brevity, some operations and/or messages, which may relate to the establishment of a PDU session in accordance with a network standard, have been omitted. The order of steps illustrated and described are also exemplary, and non-dependent steps may be performed concurrently.

In step (1), UDM 235 may store 550 subscription data that includes data indicating to use the same PCF set or the same SM-PCF set for all DNN/PDU sessions associated with UE 205.

In step (2), UE 205 may register 552 with core network 120. For example, the registration may include registering with AMF 220. As a part of a registration procedure, AMF 220 may perform a subscription retrieval procedure 553 to obtain subscription information pertaining to UE 205. For example, AMF 220 may obtain AM subscription data associated with UE 205. According to an exemplary embodiment, the subscription data may include data indicating to use PCF selection assistance information. For example, the data may be implemented as a Boolean data instance (e.g., PCF selection assistance=True).

In step (3), UE 205 may generate and transmit a PDU session establishment request 554 to AMF 220. Request 554 may include various types of data, such as a PDU session ID, PDU session type, core network capability information, among other types of information (e.g., S-NSSAI, etc.). According to this exemplary scenario, the request type may be an initial request. For example, request 554 may be the first or the initial PDU session request after completion of registering with core network 120.

In step (4), AMF 220 may perform an SMF selection 555. For example, AMF 220 may use an NRF (not illustrated) to discover an SMF or use SMF information that may be locally stored or configured. AMF 220 may select the SMF based on subscription information from UDM 235, selected DNN, the S-NSSAI, access technology used by UE 205, and/or other criteria. According to this exemplary scenario, assume that AMF 220 may select SMF-1 215-1 as the SMF to manage the first PDU session establishment request procedure. As illustrated, as part of the selection procedure, AMF 220 may provide the data (e.g., PCF selection assistance information) to SMF-1 215-1. The PCF selection assistance information may not include context information (e.g., an identifier (e.g., an instance ID, a set ID, a group ID)) associated with SM-PCF selection, as described herein. Based on this data, however, SMF-1 215-1 may use prospective context information stored in UDM 235 for PCF/SMF selection.

In step (5), SMF-1 215-1 may perform a subscription retrieval procedure 560 with UDM 235. For example, SMF-1 215-1 may retrieve session management subscription data pertaining to UE 205. According to an exemplary embodiment, the session management subscription data may include data indicating that the same PCF set or SM-PCF set is to be used for all DNN/PDU sessions associated with UE 205. As an exemplary, the data may be implemented as a Boolean data instance (e.g., SM-PCF constant=True).

In step (6) SMF-1 215-1 may perform a PCF discovery and selection procedure 567. For example, SMF-1 215-1 may query the NRF (not illustrated) to discover a PCF or an SM-PCF. Based on a result of the query, SMF-1 215-1 may select SM-PCF 230. For example, SMF-1 215-1 may select SM-PCF 230 based on the SUPI of UE 205, the subscription data, and/or other types of data (e.g., the DNN, S-NSSAI of the prospective PDU session, information provided by AMF 220, etc. In step (7), SMF-1 215-1 may obtain SM policies 569 pertaining to UE 205 from SM-PCF 230. For example, the policies may relate to a particular DNN and network slice.

In step (8), SMF-1 215-1 may generate and store context information 571 pertaining to the selection of SM-PCF 230. For example, based on the session management subscription data and the selected PCF or SM-PCF, SMF-1 215-1 may generate and locally store an identifier pertaining to SM-PCF 230, as described herein. By way of further example, the identifier may include an instance ID and a set ID. According to other examples, the identifier may include a different set of IDs, as described herein. Additionally, as further illustrated in FIG. 5A, SMF-1 215-1 may store the context information with UDM 235. According to various exemplary embodiments, the context information may include other types of data, such as a DNN, a FQDN, a PDU session ID, S-NSSAI, and/or other types of SM context data that may pertain to the PDU session.

Although not illustrated, according to an exemplary scenario, assume that UE 205 establishes and conducts a PDU session with an application server (e.g., external device 117 of external network 115, not illustrated).

Thereafter, referring to FIG. 5B and step (9), UE 205 may generate and transmit another PDU session establishment request 573 to AMF 220. According to this exemplary scenario, assume that request 573 relates to a different DNN relative to request 554. In step (10), AMF 220 may perform an AM policy retrieval procedure 575 with UDM 235. For example, AMF 220 may retrieve AM subscription data and context information (e.g., UE PDU context information pertaining to UE 205). For example, the context information may include the identifier associated with the first PDU session. The context information may include other types of information, as described.

In step (11), AMF 220 may perform an SMF selection procedure 577 resulting in the selection of SMF-2 215-2. As illustrated, AMF 220 may provide the data instance (e.g., PCF selection assistance) and the context information to SMF-2 215-2. In step 12, SMF-2 215-2 may select a PCF or an SM-PCF from the same PCF set or SM-PCF set as SMF-1 215-1 based on the context information. According to this example, SMF-2 215-2 may select the same SM-PCF (i.e., SM-PCF 230) as SMF-1 215-1. According to other exemplary scenarios, SMF-2 215-2 may select a different SM-PCF but from the same SM-PCF set as SMF-1 215-1 selected.

Although not illustrated, according to an exemplary scenario, assume that UE 205 establishes and conducts a second PDU session with an application server (e.g., external device 117 of external network 115, not illustrated) of a different network than the first PDU session. The number of PDU sessions illustrated and described are exemplary, and the number of PDU sessions established subsequent to the first or initial PDU session is not limited to a single PDU session (e.g., a second PDU session). Accordingly, the PCF selection service may enable the selection of PCF(s) and/or SM-PCF(s) associated with the same set for more than two PDU/DNN sessions.

FIGS. 5A and 5B illustrate exemplary process 500 of an exemplary embodiment of the PCF selection service, according to other exemplary processes, different and/or additional processes or operations may be performed. For example, according to another exemplary scenario in which UE 205 may be off-net or roaming, AMF 220 may be implemented as a visiting AMF (e.g., of an off-net core network). As such, the visiting AMF may retrieve the context information from the home UDM, and the visiting AMF may provide the context information to a home SMF.

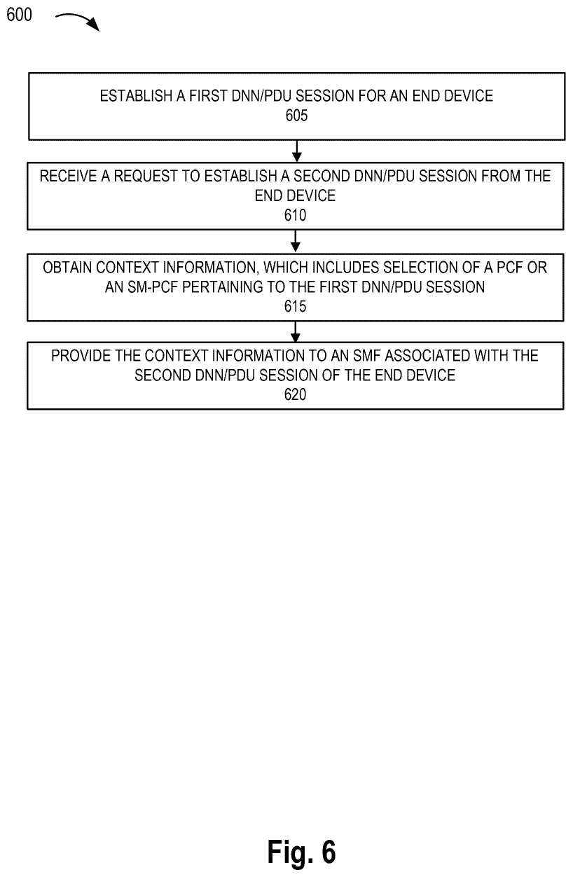

FIG. 6 is a flow diagram illustrating an exemplary process 600 of an exemplary embodiment of the PCF selection service. According to an exemplary embodiment, an AMF may perform steps of process 600. According to an exemplary implementation, a processor may execute software to perform a step (in whole or in part) of process 600, as described herein. Alternatively, a step (in whole or in part) may be performed by execution of only hardware. According to exemplary scenarios, process 600 may be performed for on-net and off-net scenarios. However, depending on the scenario, the AMF may be a home AMF or a visited AMF, for example.

In block 605, the AMF may establish a first DNN/PDU session for end device 130. For example, AMF 220 may perform operations that assist in the establishment of the first DNN/PDU session of end device 130, as described herein.

In block 610, the AMF may receive a request to establish a second DNN/PDU session from end device 130. For example, AMF 220 may perform operations that assist in the establishment of the second DNN/PDU session of end device 130, as described herein.

In block 615, the AMF may obtain context information, which includes selection of a PCF or an SM-PCF pertaining to the first DNN/PDU session. For example, the AMF may obtain the context information, as described herein, from a UDM.

In block 620, the AMF may provide the context information to an SMF associated with the second DNN/PDU session of end device 130. For example, the AMF may select the SMF to manage the second DNN/PDU session and provide the context information for use in selecting the same PCF set or SM-PCF set as the set selected for the first DNN/PDU session.

FIG. 6 illustrates an exemplary process 600 of the PCF selection service, however, according to other exemplary embodiments, the PCF selection service may perform additional operations, fewer operations, and/or different operations than those illustrated and described in relation to FIG. 6.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,”“implementations,”etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example. ” Any embodiment or implementation described as “exemplary” is not necessarily to be construed as preferred or advantageous over other embodiments or implementations.

In addition, while series of blocks have been described regarding the processes illustrated in FIGS. 4 and 6, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element. ” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
obtaining, by a network device, subscription information of an end device, wherein the subscription information includes data indicating to use a same policy control function (PCF) set or a same session management (SM)-PCF set for all packet data unit (PDU) sessions of the end device;
establishing, by the network device, a first PDU session for the end device, wherein the establishing includes selection and use of a PCF or an SM-PCF;
storing, by the network device, context information that includes an identifier pertaining to the selection; and
establishing, by the network device, a second PDU session on behalf of the end device based on the context information.

2. The method of claim 1, wherein the identifier includes an instance identifier that identifies the PCF or the SM-PCF, and a set identifier that identifies a PCF set or an SM-PCF set to which the PCF or the SM-PCF belongs.

3. The method of claim 1, wherein the storing further comprising:
storing the context information at the network device and at a unified data management (UDM).

4. The method of claim 1, wherein the first PDU session and the second PDU session pertain to different data network names (DNNs) or types of PDU sessions.

5. The method of claim 1, wherein the first PDU session and the second PDU session of the end device are on-net.

6. The method of claim 1, wherein the first PDU session and the second PDU session of the end device are off-net.

7. The method of claim 1, further comprising:
obtaining, by the network device from the PCF or the SM-PCF, session management policies of the end device.

8. The method of claim 1, wherein the network device is a session management function (SMF) of a Fifth Generation core network.

9. A network device comprising:
a processor, wherein the processor is configured to:
obtain subscription information of an end device, wherein the subscription information includes data indicating to use a same policy control function (PCF) set or a same session management (SM)-PCF set for all packet data unit (PDU) sessions of the end device;
establish a first PDU session for the end device, wherein the establishing includes selection and use of a PCF or an SM-PCF;
store context information that includes an identifier pertaining to the selection; and
establish a second PDU session on behalf of the end device based on the context information.

10. The network device of claim 9, wherein the identifier includes an instance identifier that identifies the PCF or the SM-PCF, and a set identifier that identifies a PCF set or an SM-PCF set to which the PCF or the SM-PCF belongs.

11. The network device of claim 9, wherein when storing, the processor is configured to:
store the context information at the network device and at a unified data management (UDM).

12. The network device of claim 9, wherein the first PDU session and the second PDU session pertain to different data network names (DNNs) or types of PDU sessions.

13. The network device of claim 9, wherein the first PDU session and the second PDU session of the end device are on-net.

14. The network device of claim 9, wherein the first PDU session and the second PDU session of the end device are off-net.

15. The network device of claim 9, wherein the processor is further configured to:
obtain from the PCF or the SM-PCF, session management policies of the end device.

16. The network device of claim 9, wherein the network device is a session management function (SMF) of a Fifth Generation core network.

17. A non-transitory computer-readable storage medium storing instructions executable by a processor of a network device, wherein the instructions are configured to:
obtain subscription information of an end device, wherein the subscription information includes data indicating to use a same policy control function (PCF) set or a same session management (SM)-PCF set for all packet data unit (PDU) sessions of the end device;
establish a first PDU session for the end device, wherein the establishing includes selection and use of a PCF or an SM-PCF;
store context information that includes an identifier pertaining to the selection; and
establish a second PDU session on behalf of the end device based on the context information.

18. The non-transitory computer-readable storage medium of claim 17, wherein the identifier includes an instance identifier that identifies the PCF or the SM-PCF, and a set identifier that identifies a PCF set or an SM-PCF set to which the PCF or the SM-PCF belongs.

19. The non-transitory computer-readable storage medium of claim 17, wherein the instructions are further configured to:
store the context information at the network device and at a unified data management (UDM).

20. The non-transitory computer-readable storage medium of claim 17, wherein the first PDU session and the second PDU session pertain to different data network names (DNNs) or types of PDU sessions.
